(19) United States
(12) Patent Application Publication
(10) Pub. No.: US 2005/0123885 A1
(43) Pub. Date: Jun. 9, 2005

(54) Teaching aid for counting, method and computer program therefore

(76) Inventor: Christian William Taylor, Bedfordshire (GB)

Correspondence Address: Robert D Buyan;Stout Uxa Buyan & Mullins, Suite 300, 4 Venture, Irvine, CA, 92618, US

(21) Appl. No.: 10/493,654

(22) PCT Filed: Oct. 23, 2002
(86) PCT No.: PCT/GB02/04790

(30) Foreign Application Priority Data
Oct. 23, 2001 (GB) 0125406.9

(51) Int. Cl. G09B 1/00; G09B 19/02

(52) U.S. Cl. 434/195; 434/189

(57) ABSTRACT

A teaching aid comprising a plurality of counting elements, different counting elements being used to represent different powers of number, such that, when operating in base 10: (i) a first counting element incorporates a representation of a single unit or symbol; (ii) a second counting element incorporates a representation showing ten of the units or symbols shown on the first counting element; (iii) a third counting element incorporates a representation showing ten of the second counting elements; (iv) a fourth counting element incorporates a representation of ten of the third counting element; and so on.

### FIELD OF THE INVENTION

The present invention relates to learning aids and a method of using those aids to teach the concept of number. The invention is particularly applicable, but in no way limited, to numeracy learning aids.

### BACKGROUND

This invention relates to a teaching aid designed to help learners understand and process large numbers and to understand the relationship and recognise the difference between orders of magnitude (place value), e.g. one hundred, one thousand, one million.

A wide range of physical and visual aids exist for teaching the concept of number. Typically these comprise single objects such as counters, toy animals, wooden or plastic blocks etc. each of which represent the value of one (unity). Learners initially build up the concept of number by counting these objects up to ten. Thereafter a range of other techniques exist to take learners to the higher orders of magnitude: for example, arranging or connecting objects into rows or groups of ten or more, or constructing a two dimensional matrix up to one hundred, or a three dimensional cube of up to one thousand.

However, the above devices and techniques fail to demonstrate orders of magnitude above 1,000 due to the problems of physically handling large numbers of objects and mentally holding the large values in memory. Learners may also have to think in one, two and three dimensions in order to understand the one concept of place value; learners may also become confused between place value and dimension.

Various teaching aids have been described in the patent literature, for example U.S. Pat. No. 4,585,419 (Rinaldelli), U.S. Pat. No. 5,076,793 (Aghevli) and GB 2 299 888 (Heath). However, these all require cumbersome apparatus such as counting boxes or stackable components. These have to be manufactured to close tolerances and are very heavy to use for small children. The weight of these products is a particular problem if the apparatus is used to count in very large numbers such as millions.

Similar problems are experienced with the factor block kits described in U.S. Pat. No. 5,868,577 (Aghevli).

### SUMMARY OF THE PRESENT INVENTION

According to a first aspect of the present invention there is provided a teaching aid comprising a plurality of counting elements, different counting elements being used to represent different powers of number, such that, when operating in base 10:—
a first counting element incorporates a representation of a single unit or symbol;
a second counting element incorporates a representation showing ten of the units or symbols shown on the first counting element;
a third counting element incorporates a representation showing ten of the second counting elements;
a fourth counting element incorporates a representation of ten of the third counting element;
and so on.

Preferably each type of counting element incorporates a different coloured background behind the representations(s) of the units or symbols and the background colour is used consistently whenever a particular type or value of counting element appears.

Preferably the numerical value of the counting element is shown on the reverse of the element. Any known or yet to be developed numeral system can be used for this.

The invention also encompasses a method of teaching the concept of numbers using counting elements as described herein, as well as a kit containing a plurality of counting elements, plus any combination of a work book or work books, a user's manual, and a teachers guide. Some or all of these materials can be provided in electronic form by way of computer program(s) or over the World Wide Web (Internet). This is one of the major advantages of the present invention. Because it does not involve specially designed building block, pyramids or triangles adapted to engage or stack, upwards or sideways, one with another, the components can be disseminated electronically, and thus widely and cheaply.

Using the present invention, learners can count up to any number, e.g. over a million and manipulate these numbers by working with two dimensional representations e.g. cards, each card representing one order of magnitude and relating to the previous lower order of magnitude by depicting ten symbols, each symbol representing that lower order of magnitude.

According to a further aspect of the present invention, there is provided a computer program for use as a teaching aid, said program being executable on a processor to cause representations of a plurality of counting elements to be displayed on a display device, different representations of counting elements being used to represent different powers of number, such that, when operating in base 10:—
(i) a first representation of a counting element incorporates a representation of a single unit or symbol;
(ii) a second representation of a counting element incorporates a representation showing ten of the units or symbols shown on the first counting element;
(iii) a third representation of a counting element incorporates a representation showing ten of the second counting elements;
(iv) a fourth representation of a counting element incorporates a representation of ten of the third counting element;
   and so on.

The computer program may be operable in a base other than 10.

Preferably the first, second, third, fourth and subsequent representations of counting elements each incorporate a different coloured background behind the representation(s) of the units or symbols and the background colour is used consistently whenever a particular counting element appears.

Preferably each successive representation of a counting element increases in size compared to the previous counting element in the series.

Preferably the computer program is further operable to enable a user to “zoom in” on a representation of a counting element and thereby view representations of constituent counting elements of lower orders of magnitude.

Preferably the computer program is further operable, when working in base 10, to convert a set of ten representations of counting elements of one order of magnitude to a representation of one counting element of the next highest order of magnitude.

Preferably the computer program is further operable to display conventional numbers and digits together with the representations of the counting elements

### BRIEF DESCRIPTION OF THE DRAWINGS

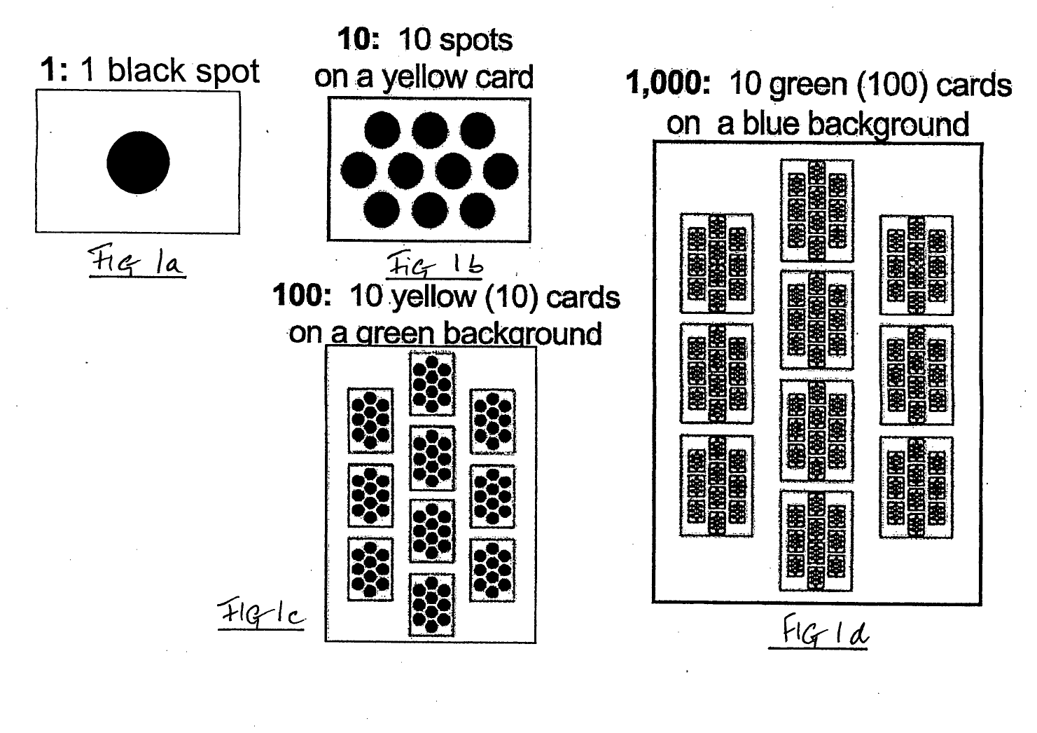

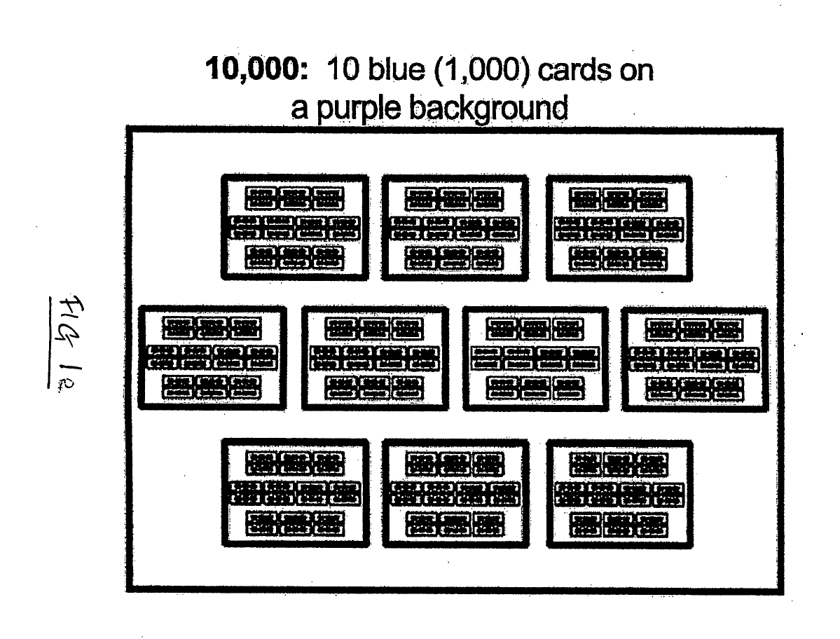

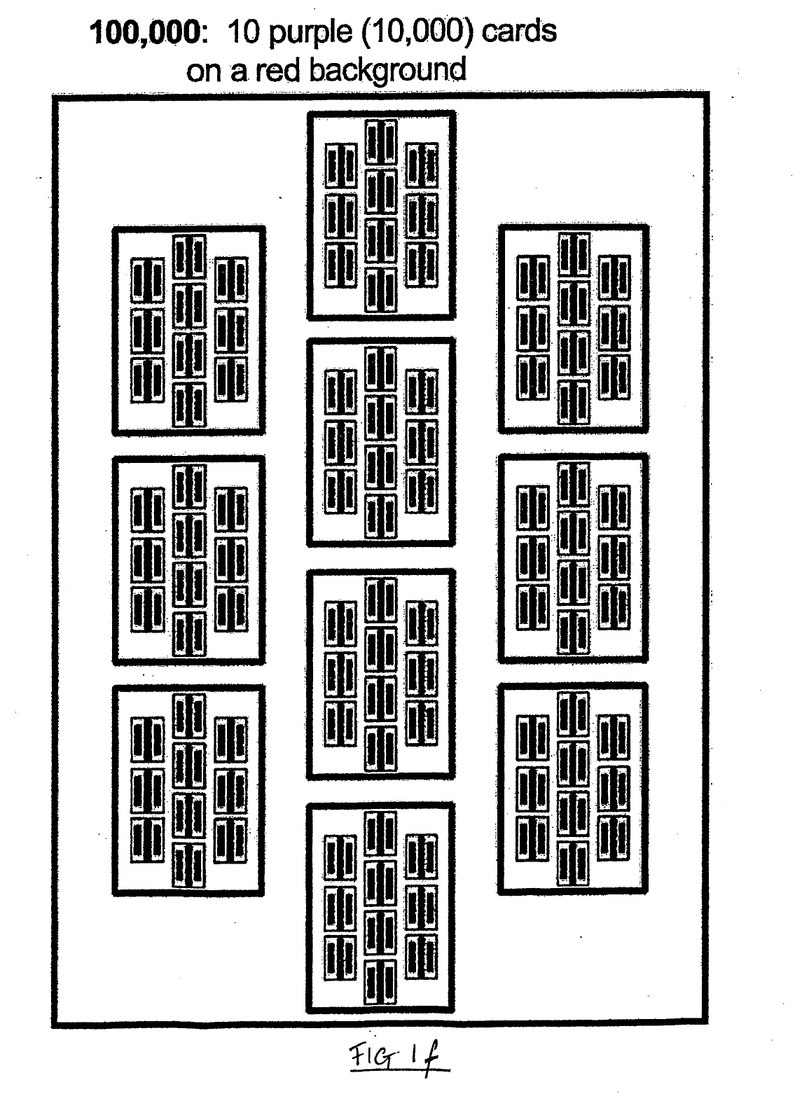

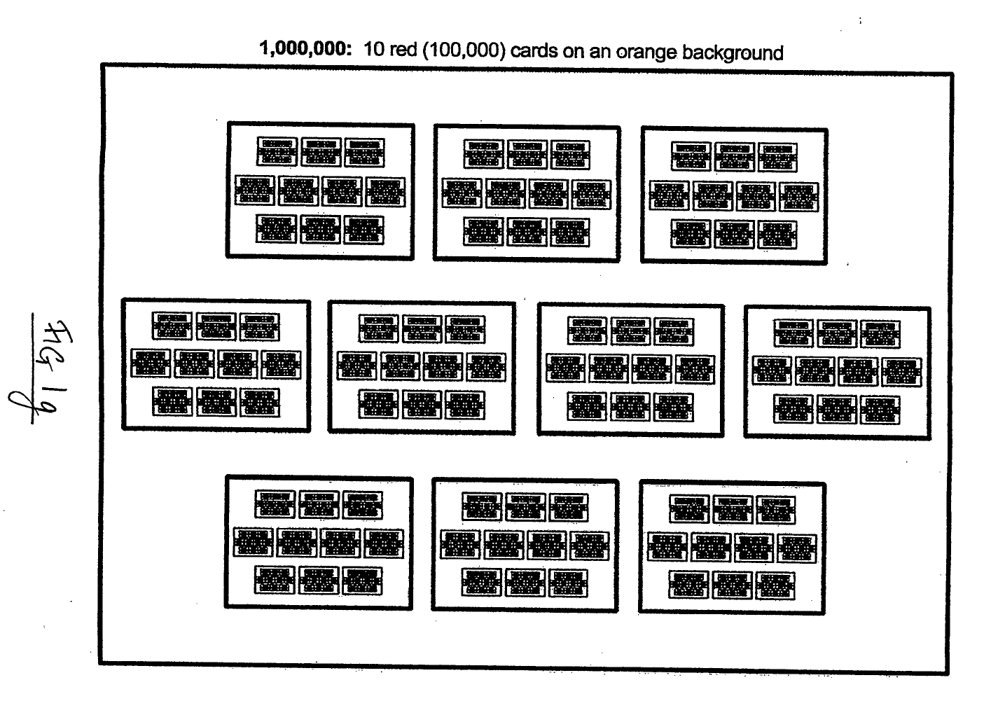

A specific embodiment of this invention will now be described with reference to FIG. 1 which shows the design for a set of cards (a to g) which depict seven orders of magnitude.

Card a) represents unity (one) and depicts a single symbol or object, in this case a black spot. Counting up to ten is achieved with reference to these 10 symbols. Leamers may alternatively use black plastic counters for this stage of counting.

Card b) represents ten by depicting ten of the symbols shown on card a), in this case ten black spots and showing these against a colour, in this case yellow.

Card c) represents one hundred by depicting 10 yellow cards, (each depicting 10 black spots, 100 in total) on a new colour of background, in this case green.

Card d) is blue and represents one thousand by depicting 10 green cards, depicting 100 yellow cards, depicting a total of 1,000 black spots.

Card e) is purple and represents 10,000 by depicting 10 blue cards and lower orders of magnitude associated with them.

Card f) is red and represents 100,000 by depicting 10 purple cards and lower orders of magnitude associated with them.

Card g) is light brown and represents 1,000,000 by depicting 10 red cards and lower orders of magnitude associated with them.

A minimum of 10 cards of each level of magnitude (except the highest) is required for the full “set”, which enables learners to visualise the relationship between 10 cards of one order of magnitude and the card representing the next highest level.

### DESCRIPTION OF THE PREFERRED EMBODIMENTS

The present invention will now be described by way of example only. These are not the only ways that the invention may be put into practice but they are the best ways known to the applicant at the present time. For the sake of clarity the following description refers to the decimal system i.e. base 10. However, it is equally applicable to other number systems i.e. base x.

The concept of high orders of magnitude is taught by learners counting up to 10 using the black (unit) cards, then substituting one yellow (10) card for the ten black ones: the learner recognises that the yellow is of the same numerical value by recognising the same 10 black spots. When the learner counts up to 100 using 10 yellow cards (with or without the black ones), a green (100) card is substituted. This is recognised as having the same numerical value as 10 yellow ones by recognising the 10 yellow cards on the green one and being able to count the 100 black spots. 10 green cards are then replaced by one blue (1,000) card, 10 blue cards by one purple (10,000), 10 purple by one red (100,000) and ten red by one brown (1,000,000). Instead of unit cards, individual counters, in this case black counters could be used.

Learners can also use these cards to add and subtract up to 6 digit numbers, by representing the digits by the relevant number of cards of the relevant order of magnitude, e.g. 523=5 green cards, 2 yellow and 3 black.

Higher orders of magnitude can be depicted in the same way as above, by selecting a different colour for each order of magnitude and depicting the ten cards of the previous order of magnitude.

Refinements in the Current Design

In the example illustrated, dots have been used to represent a unitary number in the illustrations in FIG. 1. However, the invention would work equally well with any symbol, be it a geometric shape or a pictorial representation and it should be understood that a pictorial or geometric shape could be substituted for the dots illustrated.

Each successive card may increases in size with each order of magnitude, to help communicate the increase in numeric value of each counting element. For example, the cards may double in size for each increase in place value, to help convey to pupils their increasing numerical value. The numerical value of each card (in words and digits) is shown on the back. FIG. 1 shows the designs of the cards but not their relative or actual size. Preferably the largest (1 million) card is about A4 in size.

Each counting element may be labelled on the reverse side with the numerical value as digits and/or words, to assist the learner in linking the card to the appropriate numerical value. The font size used for this information may increase proportionate to the increase in card size, again to help convey to the learner an increase in value. Learners may thus switch between the coloured symbols on the front of the card and the numeric values on the back, to aid recognition of the numerical values.

Cards may be manufactured of paper based materials, plastic or similar material and may be protected from wear and tear by appropriate methods e.g. lamination or encapsulation.

The designs may also be depicted on overhead transparency sheets for classroom demonstration.

The designs described here may be produced in any suitable colour scheme.

The present invention is equally applicable to counting in bases other than 10. In fact, the invention is suitable for counting in other bases such as base 6 or base 8.

Three-dimensional counting elements could be used in place of cards, which are only one form of counting element. The three-dimensional counting elements or counters would bear the representations shown in FIG. 1 on one of their faces.

In this teaching aid, unity is represented by either a black counter or a black spot. Individual units are represented by conventional black counters. Higher place values are represented by cards with spots, one design for each place value, as shown below, such that each card shows 10 of the lower place value cards. There are up to 5 orders of magnitude visible on each of the larger cards.

Thus the invention also includes a computer program which is adapted to display on a computer screen images of “cards” as illustrated in FIG. 1 in a sequence and combination determined by the operator or the teacher. The technical effect of this operation is that numbers may be displayed to enable the student to add, subtract, multiply and divide and generally perform number operations.

The present invention provides for the individual counting elements, and kits including batches of counting elements, teachers guides/instructions and student work books or any combination thereof, in both printed and electronic on the World Wide Web or on the Internet format.

It will be appreciated from the above description that the counting elements in the present invention do not have to be made within any specific tolerances. This is because they are not intended in use to interconnected or interlock one with another, nor are they designed to stack one on top of another. Futhermore, they do not have to fit into a tray or other container during use, only when stored. This is a particular advantage over prior art counting elements. Because of this they can be made from lightweight materials and could, for example be made from laminated paper or card.

The Use of These Designs in Computer Software

The conceptual design of this learning aid also lends itself well to use on a computer: software which generates the designs described above and allows the learner to move and place them into position on the screen, would achieve the same learning goals. Indeed, the ability to “zoom in” on a counting element and view all of the orders of magnitude would be a distinct benefit to the learner. This overcomes the problem of not being able to see the individual symbols of unity at high orders of magnitude. The software could be developed to automatically change from one order of magnitude to the next higher one when a 10^{th} counting element is added to a set of 9. It could also be designed to show conventional numbers and digits together with the counting elements as the numbers are counted and manipulated.

In summary, this invention provides a new teaching aid which uses simple graphic designs on cards to represent different place values and numbers, from 1 up to one million. They can be used for teaching the following concepts:
Addition,
Subtraction,
Place value concept,
Number bonds of 10,
Multiplication by 10,
Division by 10,
Other aspects of number

This is a cheap and cost effective method to which pupils and students can easily relate.

The following worked examples, by way of Teacher Guidelines for using apparatus according to the present invention, indicate how the invention can be used to teach numeracy skills and exemplify such a method of teaching.

[image]

[image]

[image]

[image]

[image]

1. A teaching aid comprising a plurality of counting elements, different counting elements being used to represent different powers of number, such that, when operating in base 10:—
(i) a first counting element incorporates a representation of a single unit or symbol;
(ii) a second counting element incorporates a representation showing ten of the units or symbols shown on the first counting element;
(iii) a third counting element incorporates a representation showing ten of the second counting elements;
(iv) a fourth counting element incorporates a representation of ten of the third counting element;
and so on.

2. A teaching aid according to claim 1 which operates in a base other than 10.

3. A teaching aid according to claim 1 or claim 2 wherein the first, second, third, fourth and subsequent counting elements each incorporate a different coloured background behind the representation(s) of the units or symbols and the background colour is used consistently whenever a particular counting element appears.

4. A teaching aid as claimed in any preceding claim wherein each successive counting element increases in size compared to the previous counting element in the series.

5. A teaching aid as claimed in any preceding claim wherein the numerical value of the counting element is shown on the reverse of the element.

6. A teaching aid according to claim 5 when dependent on claim 4 wherein the font size of the numerical value increases proportionately to the increase in size of the counting element.

7. A teaching aid according to any preceding claim wherein the various counting elements take the form of a card, board or plastic sheet.

8. A teaching aid according to any of claims 1 to 6 inclusive wherein the various counting elements take the form of three-dimensional counting elements or counters.

9. A teaching aid according to any preceding claim wherein the units are represented by geometric shapes.

10. A teaching aid according to claim 9 wherein the units are represented by dots.

11. A teaching aid according to any of claims 1 to 8 inclusive wherein the units are represented by a representation of an object.

12. A teaching aid as claimed in any preceding claim wherein the various counting elements are depicted on overhead transparency sheets.

13. A teaching aid as claimed in any preceding claim wherein the images of the various counting elements are stored on a computer.

14. A computer program for use as a teaching aid, said program being executable on a processor to cause representations of a plurality of counting elements to be displayed on a display device, different representations of counting elements being used to represent different powers of number, such that, when operating in base 10:—
(i) a first representation of a counting element incorporates a representation of a single unit or symbol;
(ii) a second representation of a counting element incorporates a representation showing ten of the units or symbols shown on the first counting element;
(iii) a third representation of a counting element incorporates a representation showing ten of the second counting elements;
(iv) a fourth representation of a counting element incorporates a representation of ten of the third counting element;
and so on.

15. A computer program as claimed in claim 14, operable in a base other than 10.

16. A computer program as claimed in claim 14 or claim 15 wherein the first, second, third, fourth and subsequent representations of counting elements each incorporate a different coloured background behind the representation(s) of the units or symbols and the background colour is used consistently whenever a particular counting element appears.

17. A computer program as claimed in any of claims 14, 15 or 16, wherein each successive representation of a counting element increases in size compared to the previous counting element in the series.

18. A computer program as claimed in any of claims 14 to 17, further operable to enable a user to “zoom in” on a representation of a counting element and thereby view representations of constituent counting elements of lower orders of magnitude.

19. A computer program as claimed in any of claims 14 to 18, further operable, when working in base 10, to convert a set of ten representations of counting elements of one order of magnitude to a representation of one counting element of the next highest order of magnitude.

20. A computer program as claimed in any of claims 14 to 19, further operable to display conventional numbers and digits together with the representations of the counting elements.

21. A computer program as claimed in any of claims 14 to 20 stored on a data carrier.

22. A computer program as claimed in any of claims 14 to 20 executing on a processor.

23. A teaching aid substantially as herein described with reference to and as illustrated in any combination of the accompanying drawings.

24. A computer program for use as a teaching aid substantially as herein described with reference to and as illustrated in any combination of the accompanying drawings 25. A method of teaching the concept of number consisting of counting using a teaching aid as claimed in any of claims 1 to 13 inclusive or claim 23, or a computer program as claimed in any of claims 14 to 22 inclusive or claim 24.
